(19) United States
(12) Patent Application Publication
(10) Pub. No.: US 2021/0284451 A1
(43) Pub. Date: Sep. 16, 2021

(54) DIRECTED DELIVERY SYSTEM

(71) Applicant: Clinton Graeme BURCHAT, Idalia (AU)

(72) Inventor: Clinton Graeme BURCHAT, Idalia (AU)

(21) Appl. No.: 17/262,332

(22) PCT Filed: Jul. 23, 2019
(86) PCT No.: PCT/AU2019/050772

§ 371 Date: Jan. 22, 2021

(30) Foreign Application Priority Data
Jul. 24, 2018 (AU) 2018902673

(51) Int. Cl. B65G 11/04; B64C 39/02; B65G 11/06; B65G 1/08; A47G 29/12; A47G 29/14; A47G 29/20; B65G 11/02

(52) U.S. Cl. CPC B65G 11/04; B64C 39/024; B65G 11/063; B65G 1/08; A47G 29/12; B64D 1/12; A47G 29/20; B65G 11/023; B64C 2201/128; A47G 2029/142; B64C 2201/145; A47G 29/141

(57) ABSTRACT

A directed delivery system for drone delivery of an item to a location. The directed delivery system includes a receptacle to receive the item at the location, a container to receive the delivered item spaced some distance from the container in the vertical plane. A conduit lies between the receptacle and the containers that directs the item from one to the other minimizing the risk of damage during travel. Drone delivery of the item to the location is so that the item is received in the receptacle, and directed by the conduit to the container at the desired delivery point with minimal impact.

### FIELD OF THE INVENTION

The present invention relates to directed delivery system, and in particular to a directed delivery system for drone delivery of an item to a container at a location.

### BACKGROUND OF THE INVENTION

Drone delivery is now used and being developed to deliver purchased items in many fields and industries. Amongst these are book delivery, delivery of fast food and clothing items so that a new dress or shirt may be ordered at lunch time, and be delivered in time to wear for a social occasion that evening. These are desirable services for retail and delivery companies, and significant investment is being made into research and development. In some proposed systems, a QUADCOPTER (Trade Mark) or similar small UAV drone may be used at the warehouse to pick the item or be otherwise loaded with the parcel as ordered by a person. The person making the order is typically within the same city and has made the order on-line paying with a credit card. At the time of the purchase the delivery address is confirmed, which is then tallied with a GPS (Global Positioning System—“GPS”) location which can be communicated to the drone. A journey is instructed to the drone to go to the logged GPS location. Simple drop delivery, such as to a person below is known, where the drone is sent to an open area where the 10 metre by 10 metre GPS location can be used. A person waits and at the allotted time sees the drone, waits underneath and catches the parcel. Clearly this method is fraught with potential issues, injury to the person, damage to the articles and the general inconvenience of needing to be home in order that the parcel can be delivered. To address this need to be at home to receive a parcel the inventor has developed a sophisticated system for drone delivery subject of a number of patent applications the contents of which is incorporated herein by reference PCT/AU2015/000553 and PCT/AU2017/050651 both in the name of the same inventor.

The prior inventions of the inventor looked to address the problem of the person needing to be home to take delivery, but taking delivery to direct to a location, with location means to direct the delivery within the GPS location to a specific receptacle. The various forms of invention enable the drone to communicate with a net, for example, so that the drone aligns and drops the item directly in, to pass to a container. The nets in these forms of invention are at the level of the home of the person, and the receptacle has a short chute to pass the item to a container insider. In some forms of the invention an extendible arm comes out to meet the drone and the drone aligns and delivers into the net. The extendible arm then retracts to bring the item close to the home of the person for retrieval. In some forms a funnel arrangement is used that opens to receive the item from the drone and then closes away when not in use.

There a number of variants to these forms of invention, all with inventive merit in their own right. The present inventions of the inventor each have a delivery receiving equipment for each home, so that the drone delivers to the net or funnel for the home, typically located outside a window. This requires there to be a receptacle at each level, say in a multistorey building some of these may be low to the ground, some at mid-level and some higher. For the person ordering the item it is highly desirable to have the item delivered straight to their home, for retrieval at their convenience, this is for ease and security. However, for the drone delivery it is much easier to deliver to a roof or high location so as not to encounter obstacles and to keep safely away from trees and people who may interfere with the drone. Further the number of delivery locations can be reduced so that in high density locations where there are very numerous apartments, safe an accurate delivery can still be achieved.

The inventor has therefore further developed the invention to receive the item at one location and delivery to another location, such as the home of the person, with a carefully designed conduit between them that enables the item to travel safely between the two. In this way a receptacle on the roof of an apartment building can deliver to how ever many apartments lie directly below, with the conduit designed for a smooth, low impact delivery to each apartment. The distance between the roof and many apartment blocks is high and so if an item was simply dropped in a funnel the distances and vertical drop would cause certain damage to the item. To overcome this significant problem, the invention uses direction to smoothly and gently deliver the item from the height of the roof to the level of the home, including use of directing pipes and a spiral, as an example, to slow the pace. Gates and doors are used with electronic signally to open only at the right apartment to deliver the good direct into the container where it is intended, and can be kept secure until retrieval.

The described new invention is a surprising advance over existing system allowing drone delivery to more readily be installed for the whole apartment building, making delivery simpler, and highly efficient. For the user, the item is delivered straight to a container within their home, typically through a wall to a living room or kitchen, so that the item is keep safe and contained until retrieval. Locks are used to prevent unauthorised access where there are multiple occupants of a home. The clever and useful system will be particular applicable for valuable items and electronics where it is essential that there are no impacts during delivery, as expanded upon in the description below.

Overall the inventor has developed a significant advance of the prior art, which is likely to be very well received once known about, and introduced to the rapidly growing industry.

The following describes a non-limiting example of the invention being used with reference to delivery an item to a multi-story apartment building. The invention is not intended to a multi-story apartment building delivery, other than as stated in the claims and may be used for any delivery. Further, the invention is described with use of other inventions of the same inventor, and again it is not intended to limit the scope of the invention other than as stated in the claims to this use, the subject invention may be used alone or in combination, both within the scope of the invention.

Throughout the specification and claims the term “drone” is used as a convenient means of denoting an aerial vehicle, such as a UAV or similar. The particular form or kind of drone may be varied. Other forms of delivery may also use the inventive directed delivery system instead. It is envisaged that manned delivery could also be used to drop the items into the directed delivery system. It is not intended that the use of the term “drone” limit the invention in any way, other than as limited in the claims.

For clarity, any prior art referred to herein, does not constitute an admission that the prior art forms part of the common general knowledge, in Australia or elsewhere.

It is an object of the present invention to provide a directed delivery system that at least ameliorates one or more of the aforementioned problems of the prior art. It is a further and separate object of the subject invention to provide a method of use of a directed delivery system.

### DISCLOSURE OF THE INVENTION

Accordingly, the present invention provides a directed delivery system, for drone delivery of an item to a location, the directed delivery system including:
a receptacle to receive the item at the location;
a container to receive the delivered item, spaced some distance from the container receptacle in substantially the vertical plane;
a conduit between the receptacle and the containers that directs the item from one to the other minimising the risk of damage during travel, the conduit including a spiral arrangement which direct the movement of the item between the receptacle and the container, and one or more controlled gates to direct the item into the correct container,
   wherein drone delivery of the item to the location is so that the item is received in the receptacle, and directed by the conduit through the spiral arrangement and gates to the correct container at the desired delivery point with minimal impact to the item.

Accordingly, the present invention also provides in a variant, a directed delivery system, for drone delivery of an item, to a location with multiple delivery points, the directed delivery system including:
a receptacle to receive the item at the location;
a container to receive the delivered item at each delivery point;
a conduit between the receptacle and the containers that directs the item from one to the other minimising the risk of damage during travel,
   wherein the drone delivery of the item to the location is so that the item is received in the receptacle, and directed by the conduit to the container at the desired delivery point with minimal impact.

Accordingly, the invention also provides in another variant, a directed delivery system, for drone delivery of an item to a location, the directed delivery system including:
a receptacle to receive the item at the location, and the drone delivery includes alignment with the correct receptacle within the GPS location and including a plurality of location means about the perimeter of the receptacle to specifically define where the item is to be placed, the location means being in communication with the drone such that the drone can align to the correct receptacle before release of the item within;
a securable container to receive the delivered item, spaced some distance from the receptacle, in substantially the vertical plane;
a conduit between the receptacle and the container that directs the item from one to the other minimising the risk of damage during travel, the conduit including a spiral arrangement which directs the movement of the item between the receptacle and the container, and one or more controlled gates, controlled in response to the delivery of the item by the drone, to direct the item into the correct container,
   wherein drone delivery of the item to the location is so that the item is received in the receptacle within the perimeter defined by the location means, and directed through the spiral arrangement, and through the gates to the correct container at the desired delivery point with minimal impact to the item.

Accordingly, the present invention also provides a directed delivery system, for drone delivery of an item to a location, the directed delivery system including:
a receptacle to receive the item at the location;
a container to receive the delivered item, spaced some distance from the container in substantially the vertical plane;
a conduit between the receptacle and the containers that directs the item from one to the other minimising the risk of damage during travel,
   wherein drone delivery of the item to the location is so that the item is received in the receptacle, and directed by the conduit to the container at the desired delivery point with minimal impact.

Preferably, the directing is the directing of an item from the release by the drone to a position where the item may be retrieved. The direction or directing may include parts of the receptacle. The directing, preferably takes place at least between the receptacle and the container. Preferably, the directing of the item takes place at multiple points between entering the delivery system and the container. Preferably, the directing is from entering the delivery system to direct an item to a particular container there are more than one. Preferably, the directing of the item is to direct the item only to the correct delivery point. Preferably, there are multiple containers and the directing of the item is such that the item is delivered to the correct container. There may be many different forms of direction of the item. The directing may take any suitable form.

Most preferably, the item is directed from release into the delivery system through to arrival at the correct delivery point. Most preferably, the directed delivery system directs the item from release to collection by the person.

The delivery system may include drone delivery. Preferably, the delivery system is used with a drone delivery system to delivery to a particular location. The drone delivery may be any suitable drone delivery. The delivery could be replaced with any suitable manual or automated release of an item into the delivery system. The drone may be a QUADCOPTER (Trade Mark). The drone may be controlled on a journey from a first point to a second point, the first point being where the item is loaded and the second point being the delivery location. The location may be determined by the user at the time of the order. The location may be determined by the controller of the drone. Preferably, the delivery by the drone delivers to a GPS defined location. Preferably, the drone delivery includes alignment with the delivery system as defined in PCT/AU2015/000553 and PCT/AU2017/050651, incorporated herein by reference. Preferably, the receptacle includes location means which communicate with the drone such that the drone can align to release the item within.

The item may be any suitable item. The item may be chosen from the following group: books; clothing items; coffee, tea or similar beverages; drink items; electronics; food items; games items; shoes; sunglasses; toiletries; or any item that may be ordered on-line. The item could also be ordered in person and delivered to the person's home, through use of the invention. For example, order the coffee at the station on the way home to be ready to drink at the person's home on arrival. The item may be contained within or below the drone. The item may be carried in any suitable way by the drone. The item may be suitable packaged before loading on the drone.

The receptacle is preferably adapted to readily receive the item by drone delivery. The receptacle may take any suitable form. The receptacle may be any suitable shape when viewed from above. Preferably, the receptacle is square when viewed from above. Preferably, location means of the receptacle define a shaped viewable by the drone for alignment of the drone and the receptacle. The receptacle may form part of the conduit in other forms of the invention.

Preferably, the receptacle assists in receipt of the item from the drone. Preferably, the receptacle is substantially funnel shaped. The angle of the walls of the funnel may be configured to be suitable for particular kinds of delivery. The angles of the walls of the funnel may form part of the directing. The item is received within the receptacle such that it can be directed and pass through to the next part of the delivery system. Preferably, the receptacle is configured to gently receive the item without undue impact and direct on to the conduit.

Preferably, the receptacle is installed near a roof of a building. Preferably, there is a single receptacle installed to direct delivery to a multiple of delivery points. Preferably a single receptacle may receive items for a number of destinations and the directing at different points between the receptacle and the container determine the container where the item is to be delivered. There may be a receptacle to delivery to each column of apartments in an apartment block. Other suitable combinations may be possible.

The container may take any suitable shape. Preferably, the container is lockable. Any suitable lock may be used. A mobile phone lock may be used. Preferably, the item may only be retrieved from the container on authorised access to the container. The container is preferably located inside a building. Preferably, the container is positioned conveniently at bench height within a home for retrieval. In other forms of the invention the container may be located about a home instead. The delivery point is the point where a person can retrieve the item and preferably, this is a very convenient place.

Preferably, each delivery point includes a container and the direction of the item directs the item from the receptacle to the correct delivery point. Preferably, an angled part between the conduit and container, goes between a substantially vertical plane of the conduit and substantially horizontal plane of the container. Preferably, the angled part assist to direct and slow the item into the container.

The conduit may take suitable shape. Preferably, the conduit is adapted for the item to travel from the receptacle to the container without damage. The item may travel a significant distance in the vertical plane. The item may be travelling from roof top to a ground floor apartment or any apartment in between and does so without risk of damage.

The conduit may include a slowing mechanism, to slow, direct and control the flow of the item between the receptacle and the container. The conduit may including an elevator to take the item from the receptacle to the correct delivery point. In this form of the invention the control may be from the drone or via a mobile phone network. The elevator may tip the floor towards a delivery exit so that the item passes to the container for removal. Preferably, controls direct the elevator to only the correct delivery point. Gates or doors may be included to prevent accidently delivery.

The slowing mechanism may include fingers, brushes or similar that slow the natural decent of an item under gravity. These fingers, brushes or similar may be varied through the height of the apparatus according to the need to slow the item. These fingers or brushes may be used in combination with any of the other forms of invention.

The conduit may include any form or forms of slowing mechanism. These may include pressure gates that release one at a time on contact with the item to slowly direct the item in the vertical plane until the correct height is reached. The item may then be retrieved. Or preferably, the item is tipped to the container for convenient retrieval.

The conduit may include a spiral arrangement which directs the movement of the item. The conduit may contain a spiral arrangement. The spiral arrangement may also slow the decent. Preferably, the spiral is adapted to fit within the conduit from receptacle to the container. Preferably, there are multiple delivery points and the spiral arrangement can carry the item to these. Preferably, the spiral arrangement includes one or more gate. Preferably, the spiral arrangement includes a gate, which on opening allows the item to pass to the container of the correct delivery point. Preferably these gates are controlled wirelessly to open to direct the item to the correct container and delivery point. Preferably, the gate when open prevents the item from passing the entrance to the correct container. Other forms of gate may be included instead. The wall of the gate may be curved. The wall of the gate may include a tapered point.

The conduit may include a wall. The conduit may be a route between the receptacle and the container. In some forms of the invention the conduit may have not walls and be a route, passage or framework in which something else travels. For example, in the elevator form of the invention, the conduit may be the travel path of the elevator, with our without walls. In one form of the invention the conduit may include mesh or wire walls.

Preferably, the item may be delivered in the same orientation as loaded to the drone. Preferably, the item can travel the whole way in the same orientation, until retrieval. Preferably, there is no significant impact to the item during use of the delivery system. Most preferably, the delivery system may be useful for delicate items or items that need to be kept upright during delivery.

In other forms of the invention the spacing in the vertical plane may be replaced with any suitable spacing not limited to the vertical plane.

Preferably, in some forms of the invention the container is an apartment itself, so that the item is delivered into the locked apartment.

Accordingly the invention provides in a further variant a directed delivery system, for drone delivery of an item, to a location with multiple delivery points, the directed delivery system including:
a receptacle to receive the item at the location;
a delivery point;
a conduit between the receptacle and the containers that directs the item from one to the other minimising the risk of damage during travel,
   wherein the drone delivery of the item to the location is so that the item is received in the receptacle, and directed by the conduit to the desired delivery point with minimal impact.

Accordingly, the invention also provides, in a variant, a directed delivery system, for drone delivery of an item, to a location with multiple delivery points, the directed delivery system including:
a receptacle to receive the item at the location;
a container to receive the delivered item at each delivery point spaced some distance from the container in the vertical plane;
a conduit between the receptacle and the containers that directs the item from one to the other minimising the risk of damage during travel,
   wherein the drone delivery of the item to the location is so that the item is received in the receptacle, and directed by the conduit to the container at the desired delivery point with minimal impact.

The delivery system may include any of the features described above.

Accordingly, the invention also provides a method of directed drone delivery, to a directed delivery system including a receptacle, conduit and container, for receipt of an item to a location, including the following steps:
a) receiving an item in a receptacle;
b) directing the item via the conduit in a controlled manner; and
c) containing the item at the delivery point, ready for retrieval by the user.

The delivery system of the method may be the delivery system of the invention in any of its forms or variants.

### INDUSTRIAL APPLICABILITY

The directed drone delivery system can be manufactured industrially and supplied to the end user, builder or installer for installation in a building. The parts may be supplied in kit form or partially or fully assembled as appropriate.

It will be apparent to a person skilled in the art that changes may be made to the embodiments disclosed herein without departing from the spirit and scope of the invention in its various aspects.

### BRIEF DESCRIPTION OF THE DRAWINGS

The invention will now be described in connection with the following non-limiting preferred embodiments with reference to the accompanying drawings, in which:

FIG. 1 is a front stylised view of a building with 4 different preferred embodiments of the invention shown installed for directed drone delivery of an item to a delivery point, with the mechanism of directed delivery shown for each embodiment, and a drone is shown approaching to make the delivery;

FIG. 2 is the front stylised view of the building of FIG. 1, as would be seen in use, with the mechanism of the directed delivery of the 4 preferred embodiments covered;

FIG. 3 is the stylised view of the building, and 4 embodiments of FIG. 1 viewed from below;

FIG. 4 is the stylised view of the building, and 4 embodiments of FIG. 2 viewed from below;

FIG. 5 is a perspective view from below, from one side of the stylised view of the building, and 4 embodiments, of FIGS. 1 and 3;

FIG. 6 is a perspective view from below, from one side of the stylised view of the building, and 4 embodiments, of FIGS. 2 and 4;

FIG. 7 is a perspective view from below, from the other side of the stylised view of the building, and 4 embodiments, of FIGS. 1, 3 and 5;

FIG. 8 is a perspective view from below, from the other side of the stylised view of the building, and 4 embodiments, of FIGS. 2, 4 and 6;

FIG. 9 is a perspective view from above, from one side of the stylised view of the building, and 4 embodiments, of FIGS. 1, 3, 5 and 7;

FIG. 10 is a perspective view from above, from the other side of the stylised view of the building, and 4 embodiments, of FIGS. 2, 4, 6 and 8;

FIG. 11 illustrates a perspective view of the directed delivery system according to a first preferred embodiment of the invention of FIGS. 1 to 10, but shown separate to the building and other embodiments;

FIG. 12 is the perspective view of the directed delivery system of FIG. 11, as shown in FIGS. 1 to 10;

FIG. 13 is a detailed perspective view of embodiments 3 and 4 of FIG. 1, just below the receptacles, and the corresponding apartments;

FIG. 14 is a detailed perspective view of embodiments 2, 3 and 4 of FIG. 1, showing a straight drop part of the conduit;

FIG. 15 is a detailed perspective schematic view of part of the conduit of embodiment 3, illustrating the spiral and gate;

FIG. 16 is a perspective view from the front of embodiments 1, 2 and 3 of FIGS. 1 to 10 showing the various delivery point exits for the system;

FIG. 17 is a perspective view from the front of embodiments 1, 2 and 3 of FIGS. 1 to 10 with the drone approaching the first embodiment receptacle for delivery;

FIG. 18 is a detailed perspective view of embodiments 1 and 2 of FIG. 17;

FIG. 19 is a perspective view of inside the apartments of FIGS. 1 to 10, showing the room of the delivery point and container;

FIG. 20 shows a detailed view of the delivery point and container of FIG. 19;

FIG. 21 shows a perspective view of the spiral mechanism as used in embodiment 3 for the delivery of an item smoothly to the delivery point;

FIG. 22 shows the perspective view of FIG. 21 from the rear;

FIG. 23 is a plan view from above of the spiral mechanism of FIGS. 21 and 22 illustrating the gate, in an open position allowing the item to pass into the container at the delivery point;

FIG. 24 is the plan view from above of FIG. 23 with the gate closed, blocking the way to the delivery point and container;

FIG. 25 is the plan view from below of FIG. 23;

FIG. 26 is a detailed view of the spiral mechanism of FIG. 21 from behind and with the gates removed to illustrate the hinge;

FIG. 27 is a detailed perspective view from above of spiral mechanism of FIG. 26;

FIG. 28 is a perspective view of the gate of the spiral mechanism of FIG. 21; and

FIG. 29 is a perspective view of the gate of FIG. 28, from behind.

### DETAILED DESCRIPTION OF THE INVENTION INCLUDING A BEST MODE

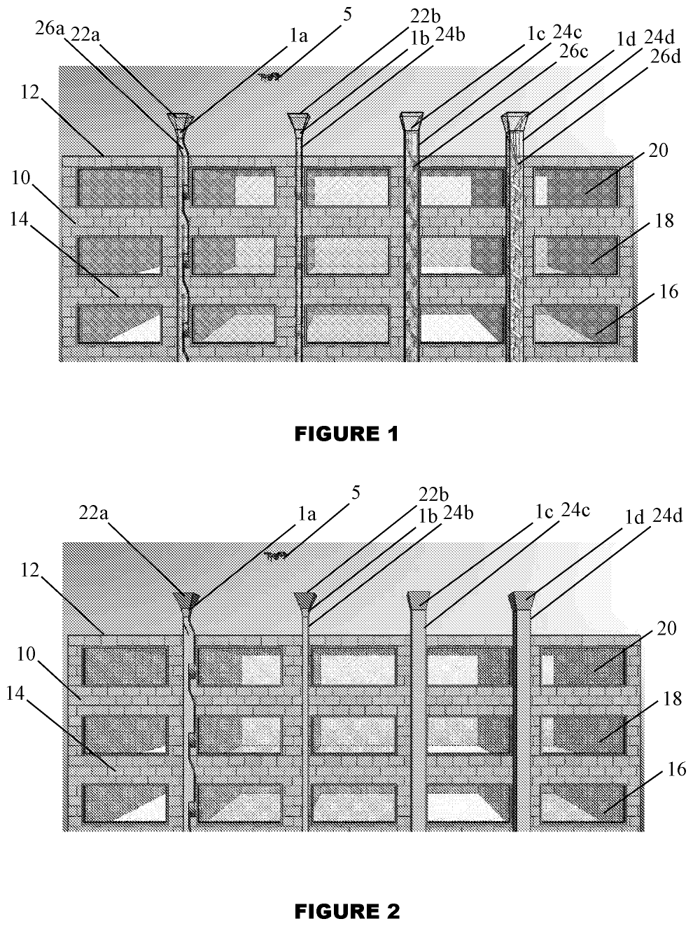

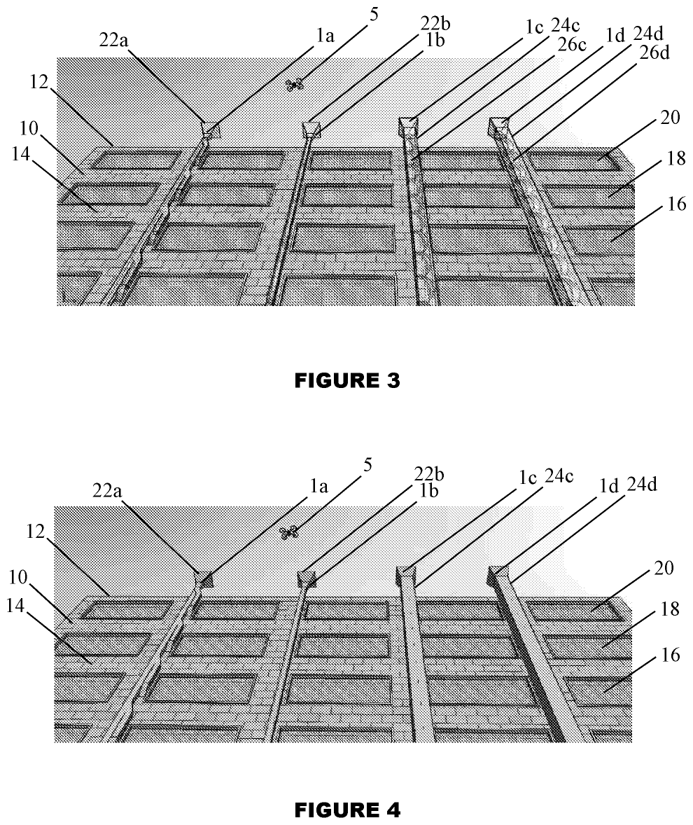

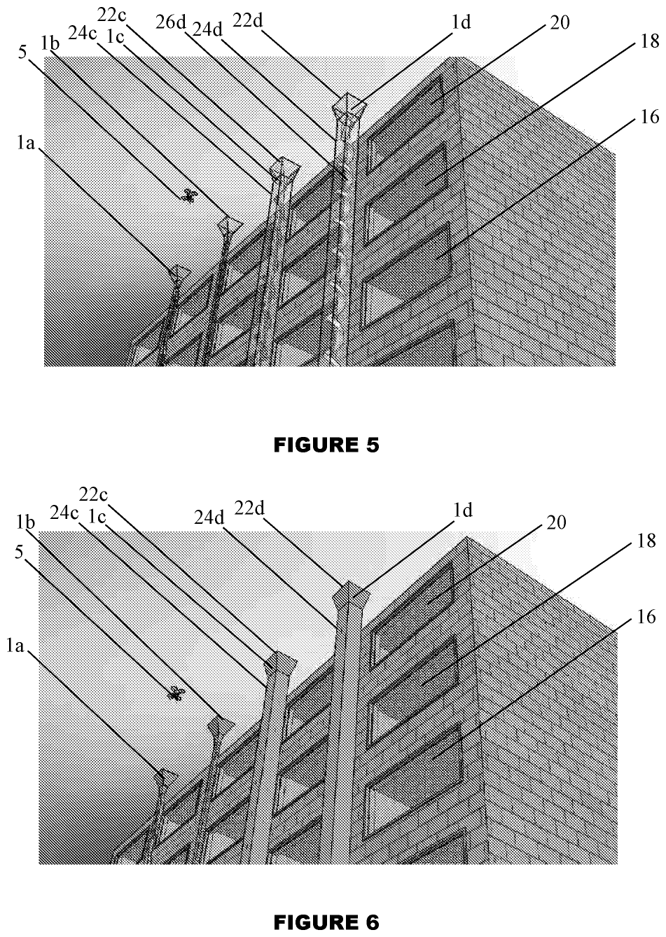

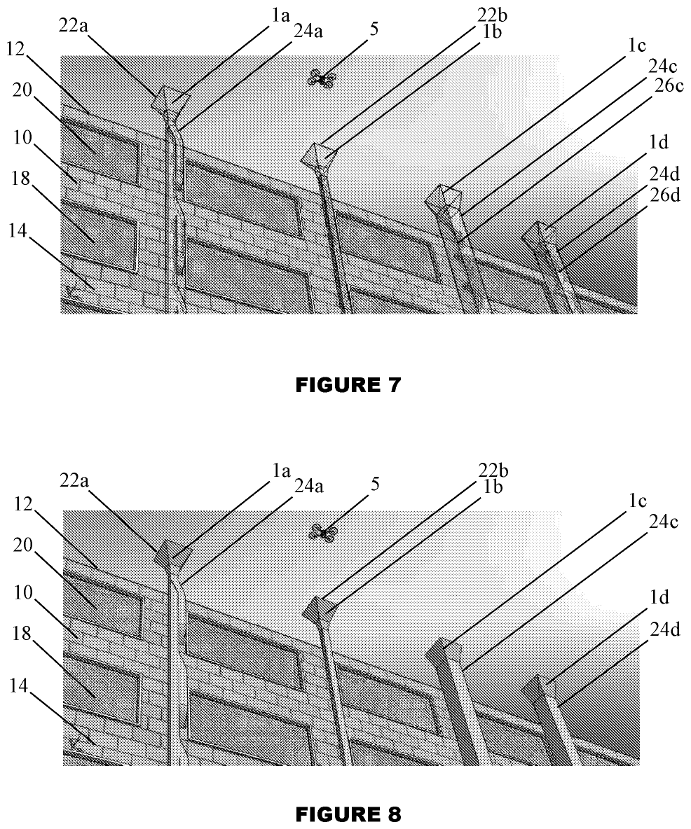

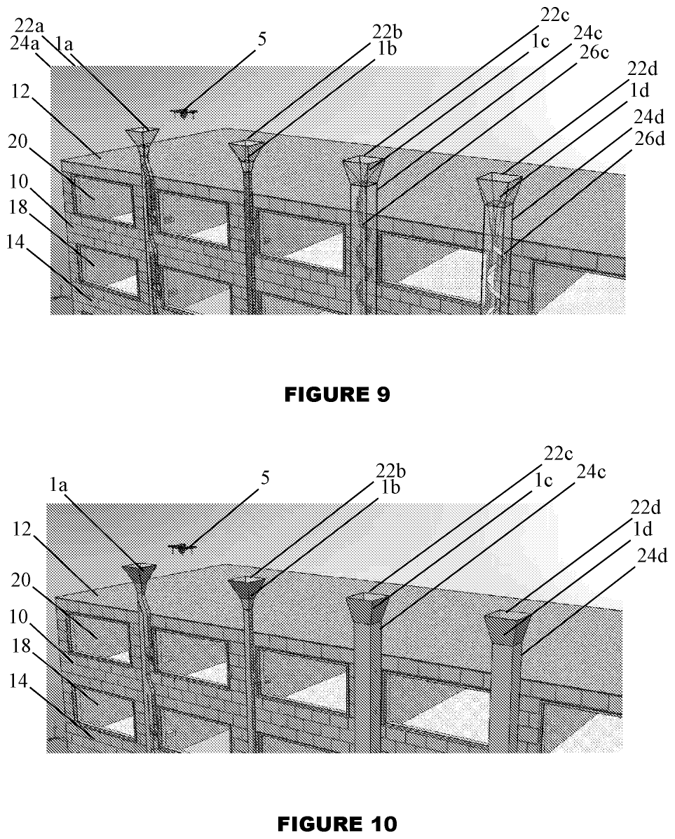

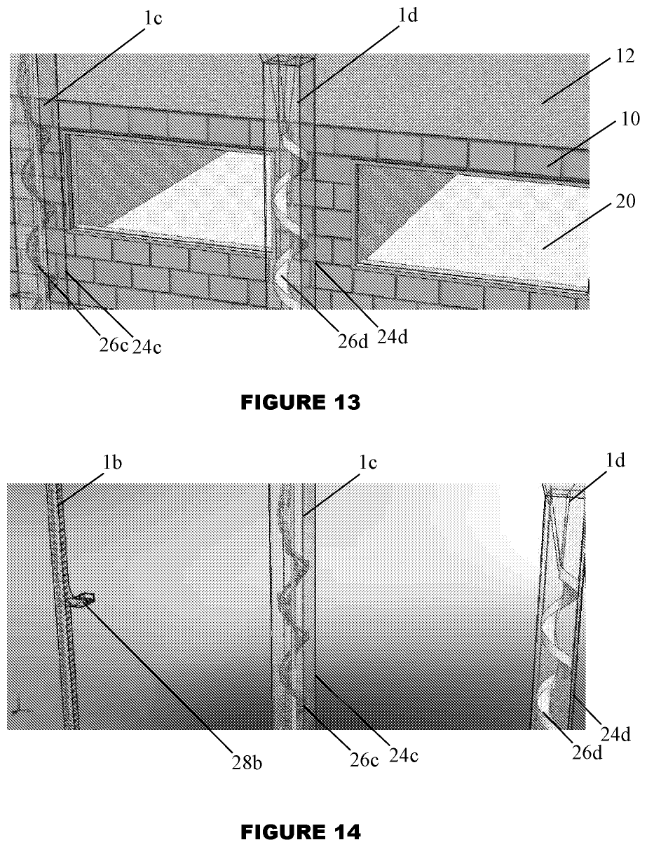

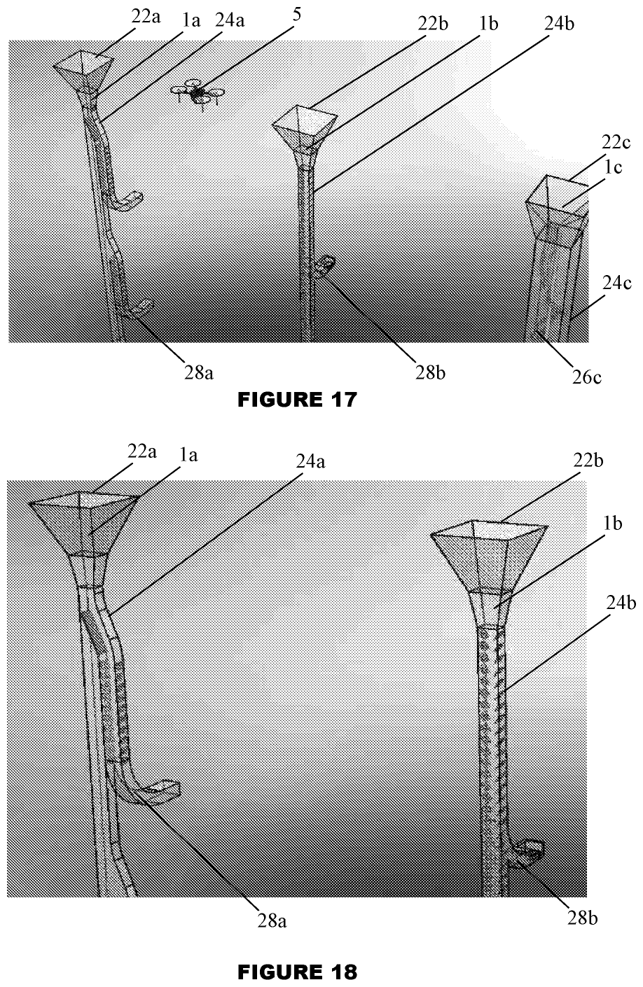

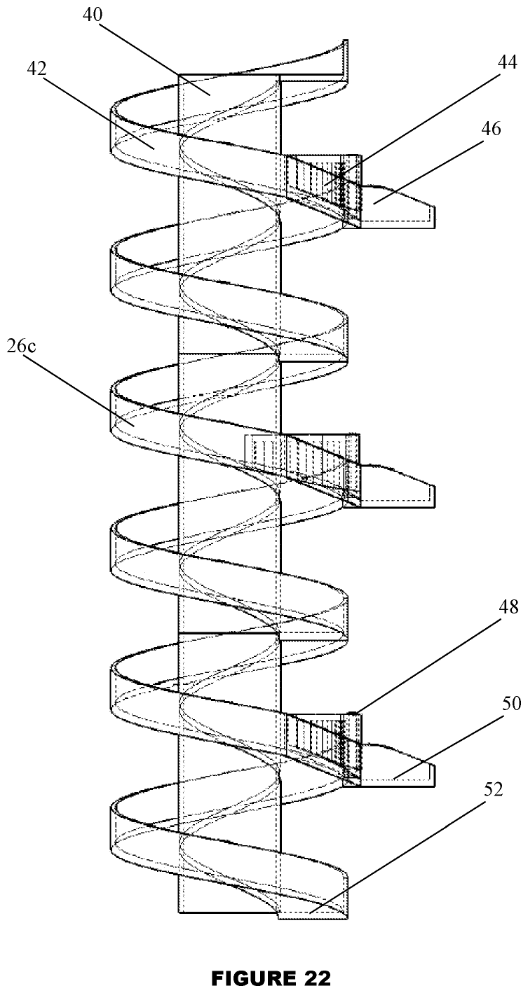

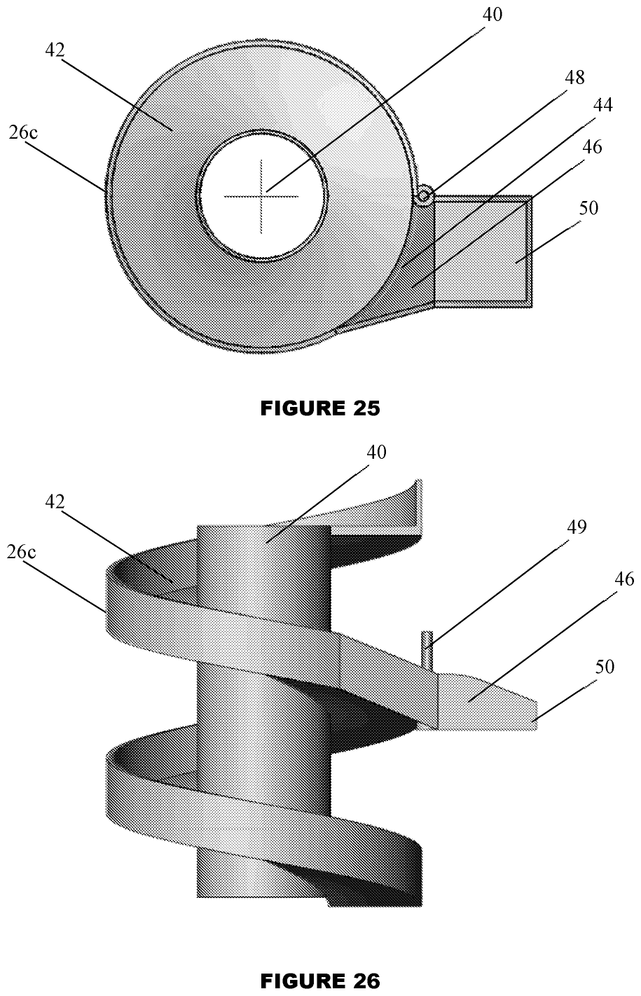

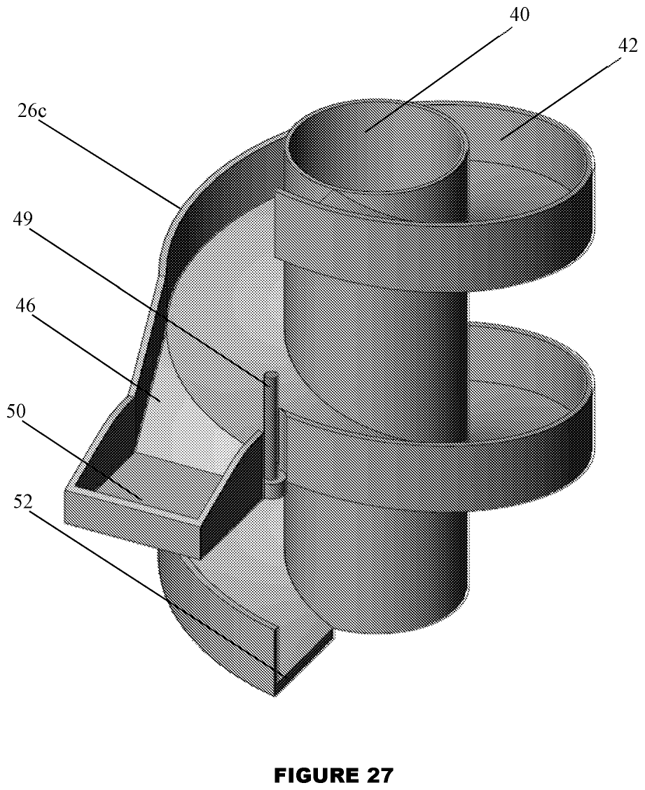

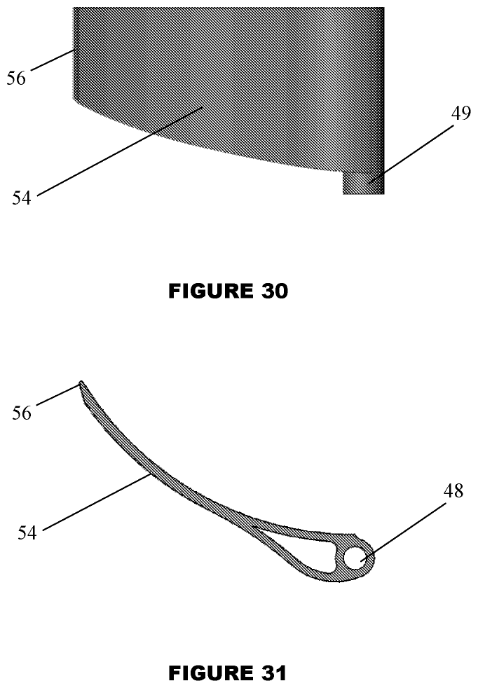

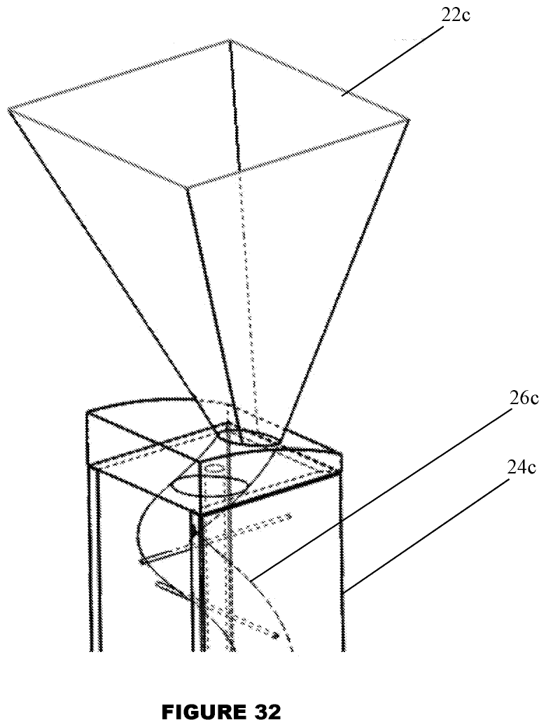

Referring to FIGS. 1 to 31 (Embodiments 1 to 4 together), a preferred embodiment of the invention will be described in 4 variants, where delivery system 1 is shown and the 4 variants are distinguished where the parts are different by inclusion of the letter “a” after the reference numeral, for the first embodiment, “b” for the second embodiment, “c” for the third embodiment and “d” for the fourth embodiment. Delivery system 1a, 1b, 1c and 1d are similar, with differences notable in general terms that 1a, has a chute system to gently direct the item to the correct delivery point, 1b with fingers or brushes to slow descent, and 1c and 1d include the variants on the spiral forms of the invention, with gates which only open to the correct delivery point so that the item smoothly travels to and through the open gate, for delivery.

Therefore delivery system 1a, 1b, 1c and 1d can be seen illustrated in FIG. 1, with drone 5 approaching to make the delivery. Drone 5 is illustrated as a popular QUADCOPTER (Trade Mark), but clearly any suitable delivery vehicle may be used instead. The journey is set by the controlling company from the depot where the item is loaded to the drone, to the location where the delivery is to be made using a GPS location as usual. The journey is set, logged and tracked in the usual manner from the dispatch point, through to the GPS location for the delivery. At this point the control of the drone is assisted by location devices around the edge of the receptacle (refer to the inventive mechanism as described to align with the outline of the receptacle and funnel of PCT/AU2015/000553 and PCT/AU2017/050651 of the inventor) so as to align with the opening. Once the drone is suitably aligned the item that has been carried from the depot to the delivery location can then communicate to release the package, as described in detail in the earlier patent applications. The funnel and alignment mechanism is as described in the earlier patents PCT/AU2015/000553 and PCT/AU2017/050651, the contents of which is incorporated herein by reference.

Building 10 is shown throughout as a multi-level apartment building as a useful example, with roof 12 and front wall 14, with floors 16, 18 and 20 shown illustratively. Floor 16 is shown as the lowest shown floor, with 18 and 20 floors respectively above. The directed drone delivery is particularly useful for multi-residence apartment blocks as a single receptacle on the roof can be delivered to and the package directed to the correct floor and apartment through use of the gates and gate controls as described below. The building could have any number of multiple floors and could in fact be a very high building with 10s or 100s of floors to deliver to, the invention would work the same and work very well in this context.

Each of funnel receptacles 22a, 22b, 22c and 22d of delivery systems 1a, 1b, 1c and 1d can be seen to be located high above roof 12, which is suitable for ready delivery. By having funnels 22a, 22b, 22c and 22d high on the roof this avoids much of the risk of obstruction through trees, poles, people or other buildings. The precise GPS location can be directed through use of the drone control to arrive at the building and then the inventive alignment system used to align with the correct funnel receptacle for delivery to a home below. In the example a single building has 4 different variants installed, but while this is possible it is probable that a single variant will be found most useful and all of the installed delivery systems on a building will be the same.

Each funnel receptacle 22a, 22b, 22c and 22d connects with a corresponding conduit 24a, 24b, 24c and 24d, each being configured slightly different to contain the direction mechanisms chutes and spirals 26a, 2bb, 26c and 26d, as described further below, individually, to direct items to delivery chute exit 28 (refer FIG. 20).

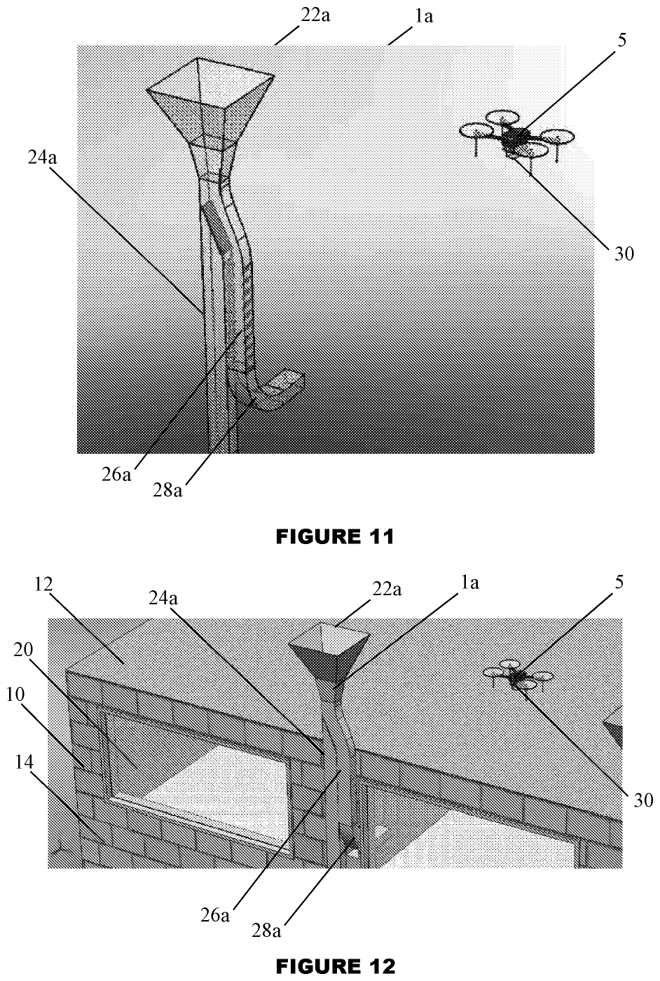

Package 30 is present in the Figures with drone 5, suspended below where it was loaded at the depot. Package 30 is marked illustratively in FIGS. 11 and 12 and then in FIG. 20 showing one form of delivery. Package 30 could be any kind of package but in the illustrated example is a delivery of hot take-away food in a plastic lidded container. Delivery of take away food is a good example of a useful use of the invention as a quick delivery after an on-line order enables drone delivery but the delivery must the carefully made to the correct address and in such a way as to deliver the food safely. The invention enables a smooth impact free delivery, it is intended that the item arrive in a substantially upright manner, to be removed and consumed.

The package could also be a retail item, packaged and ready for use, such as clothing or shoes. The package could contain electronics or valuable items, so the careful delivery with no impact prevents damage to the item. Further the delivery to the locked container described above means that the item is kept safe and secure until the owner can retrieve the item. Use of a mobile phone lock may be useful to ensure the correct owner retrieves the package, but any sort of security may be used.

Each of the embodiments 1a, 1b, 1c and 1d share the common features of drone 5 being instructed from central control to fly to the location, using GPS. Once at the location, location means (not shown) of funnel receptacles 22a, 22b, 22c and 22d assist to align drone 5 to be directly above. Once directly above package 30 can be released and passes into funnel gently, as the drone is very close, and smoothly slides on the angled sides into conduit 24a, 24b, 24c and 24d and into delivery chutes and spirals 26a, 26b, 26c and 26d. Each delivery system 26a, 26b, 26c and 26d is separately described below but each carefully delivers package 30 down to the appropriate level of the delivery point, where package 30 should ultimately end up, at delivery chute exit 28a, 28b, 28c (28d not shown). Delivery chute exit 28 includes container 32 with lockable door 34.

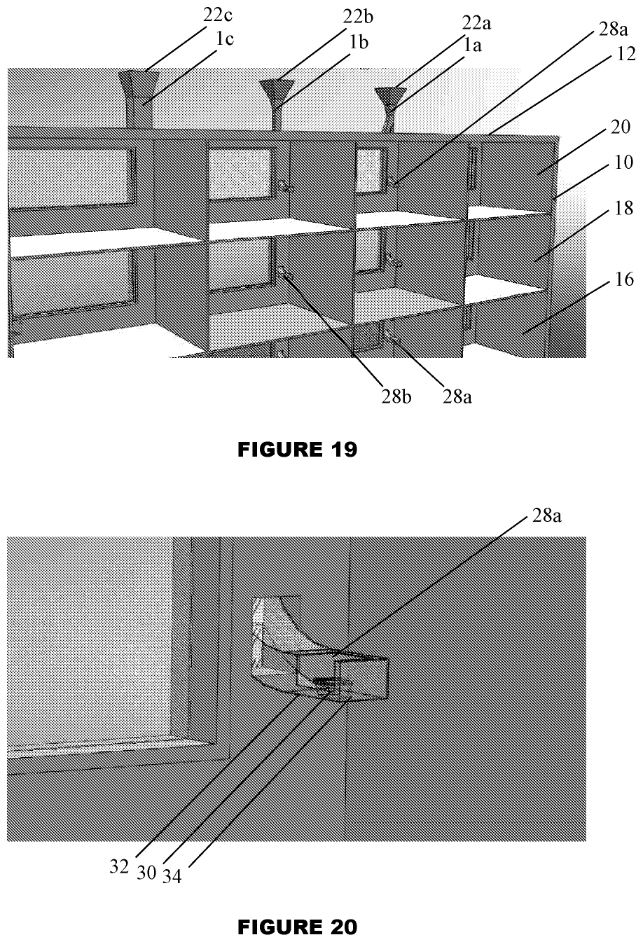

Delivery chute exit 28a, 28b, 28c (not shown for embodiment 4) can take many different forms but as illustrated (refer in particular to FIGS. 19 and 20) is the same for all 4 embodiments. A hole is made in wall 14 during installation of delivery system 1a, 1b, 1c or 1d such that a convenient delivery point is created for retrieval of the ordered item. Conduit 24a, 24b, 24c and 24d all go from vertical to horizontal before becoming horizontal container 32. Horizontal container 32 is convenient to retrieve the item being positioned at a height similar to the height of a window so retrieval can be made without the need to bend down or reach up unduly. Conventional locks with a physical or electronic key can be for lockable door 34 in the usual manner. Use of a safe, locked container 32 is particular useful to keep the item secure until the authorised user is home, and enables remote ordering and delivery without the person being home. Otherwise, the home itself can be the secure container as once delivered into a home only the authorised occupants with a key will be able to access the package.

The level surface of container 32 will keep package 30 and the contents upright. Where package 30 contains take away food this may be ordered on the train home and be there, ready to be taken out and eaten when the person gets home. Take away food can be messy and is generally well packaged but dues need to be kept upright to prevent spillage. The clever system allows for this and the package, which may be a plastic container with a lid remains, as if on a counter top, ready for collection. Similarly, where the item is a delicate electronics item, the item is quickly and smoothly delivered to the final deliver point and then kept on a level surface in the same orientation and loaded at the depot-a key advantage to the invention.

In each of the 4 embodiments the item is delivered carefully, and can be retrieved from within the home of the person at their convenience an advance on the prior art.

The description will now continue to describe the different delivery systems for each of the 4 variant embodiments. Referring to FIGS. 1 to 12, and 16 to 20 (Embodiment 1), a first preferred embodiment of the delivery system, delivery system 1a, with delivery chute 26a will be described, where narrow funnel 22a is shown suitable for receipt of items. The first embodiment will let the package fall until at the level of the desired apartment where the package will be directed horizontally (by the gate as shown in FIG. 11) then slowed with the fingers/brushes in the parallel chute. A further and final chute system like 26a on the ground floor will be adapted to slow the item for the lowest level.

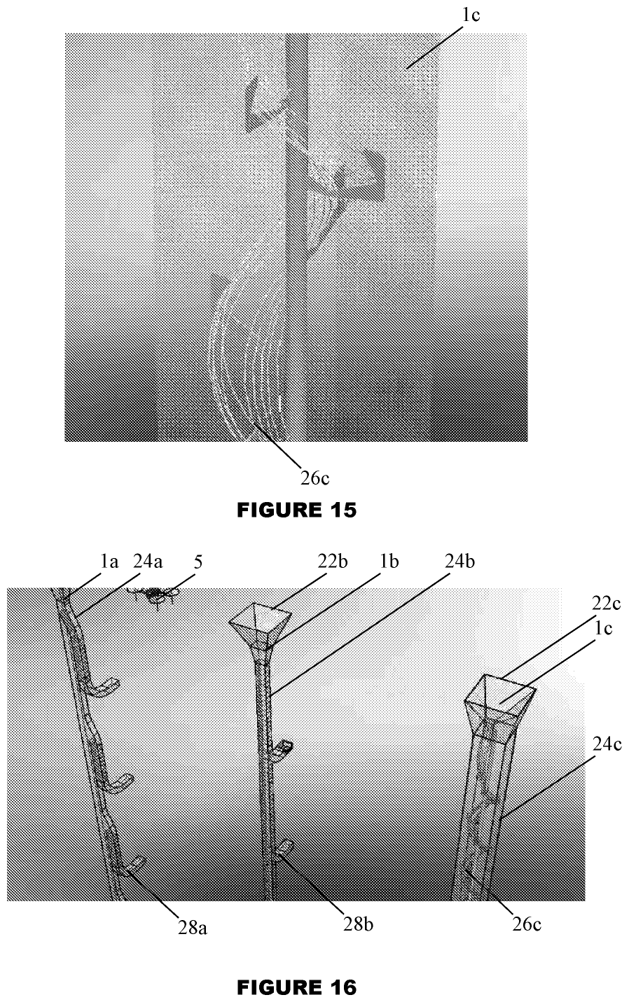

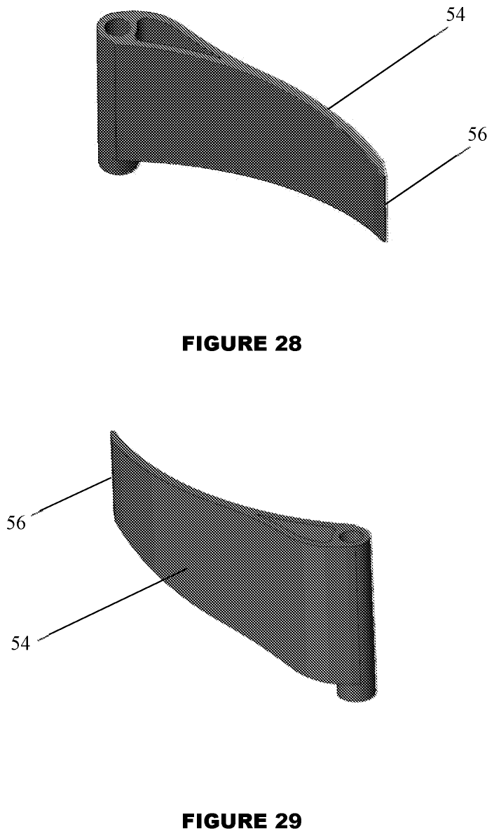

The third is a spiral chute (FIG. 15) where the surface that the package sits on, as it makes its way down the spiral, is made up of wires or tubes. This removes a lot of surface friction that the package has to overcome to descend so the spiral can be tighter and less steep. The gates to direct the package horizontally are the same as FIGS. 28-31. This design also lets rainwater fall through the spiral effortlessly. This will most likely be the design we end up building.

The fourth is a solid version of the third design where the surface that the package descends upon is solid.

Narrow funnel 22a can receive most sized items but may be particularly suitable to small electronics items, clothing or delivered food containers. Narrow funnel 22a takes receipt of package 30 from drone 5, and the package gently passes from the walls to conduit 24a which is gently sloped towards deliver chute 26a. The mechanism could also include the spiral mechanism described for the later embodiments in combination.

FIGS. 11 and 12, and 16 to 20 illustrate delivery system 1a, with drone 5 approaching, ready to deliver to delivery chute 26a. After alignment of drone 5 with funnel 22a, as described elsewhere, package 30 is released down conduit 24a and to delivery chute 26a to delivery chute exit 28a, as shown at floor 20 of building 10. The package, whatever it may contain, is directed by conduit 24a and the internal fingers so that the journey of the item is controlled to gently slow after release to arrive at the horizontal delivery chute exit 28a. The number and size of these fingers can be adapted to suit the needs of the user, size of the item and the height of the drop.

There is a repeat of the part shown labelled 26a, for each delivery point connected to conduit 24a, a key advantage of one form of the invention to deliver to many homes from a single release point. Drone 5 has been aligned with the correct funnel for release, before there is further communication to open the gate to allow package 30 only to travel to the correct delivery point and delivery chute exit 28a. The locked container of exit 28a can be accessed through use of a mobile phone lock to enable package 30 to be removed and the container relocked. All other gates are closed so that once package 30 is released it is directed through the communicated controls.

The clever direction of the item to the specific delivery point for retrieval, the home of the customer is an advance in the art, which is likely to prove very popular with suppliers and customers. There are many practical advantages to avoiding obstacles and minimising infrastructure, as well as the very great convenience to the consumer that the item is ready to simply remove from the locked container when they are ready to do so. The item is on a level surface and sitting as if on a bench top, perfectly presented. The item can remain safe and secure in the container indefinitely until authorised access occurs. Referring to FIGS. 1 to 10, and 14, 16 to 19 (Embodiment 2), a second preferred embodiment of the delivery system, delivery system 1b is illustrated which is very similar to delivery system 1a The second embodiment is very similar to the first however the package is slowed by the fingers/brushes as soon as it enters the main chute then moved horizontally (like the first chute) into a much shorter parallel chute (without fingers) at the desired level.

Again, drone 5 delivers to delivery chute 26b after alignment to release the package into funnel 22b, as described elsewhere. Funnel 22b is the smallest illustrated funnel as may be particular useful for small packages. The opening of funnel 22b is the same as the others but the sides are of a greater angle than funnel 22a for example.

Once package 30 is released down conduit 24b the package passes slowly to deliver the item to delivery chute 26b and delivery chute exit 28b (refer FIG. 16). There are chutes for each delivery point and controls of drone 5 enable gates (not shown) to be opened or kept closed so that package 30 can only be directed to the correct delivery chute exit 28b. As described for delivery system 1a delivery chute exit 28b is configured to be horizontal, a locked container for easy retrieval by the person.

Referring to Referring to FIGS. 1 to 10, and 13 to 17, 19 and 21 to 31 (Embodiment 3), a third preferred embodiment of the delivery system illustrating a spiral directing of the item from release to delivery point. Delivery system 1c is similar to the first 2 described embodiments, with funnel 22c leading to conduit 24c through to delivery chute exit. Funnel 22c is sized to have the same size opening as the other 3 but the opening between funnel 22c and conduit 24c is wider to allow larger sized parcels to be delivered. Conduit 24c is wider all the way down as can be seen in particular in FIGS. 1 and 2. The method of use is the same for these parts as described elsewhere and delivery chute exit is as described for the first two embodiments.

Different to the first two embodiments, delivery spiral 26c replaces delivery chute 26a and 26b, and it is through sliding down the spiral. Use of the spiral is particularly useful to smoothly slide the item in the correct orientation from a high position to a low position without impact or risk of damage. Even a significant height between the point of release and the delivery point can, in this way be traversed without damage. Post 40 runs centrally and it is around this that the spiral runs, in channel 42. Channel 42 is sized to receive the goods and direct them properly to the exit.

Cleverly, each delivery point and delivery chute exit (not shown) can have an item pass by to a lower level if gate 44 is closed. There are multiple gates, one each for each exit, so several gates 44 may be passed before an open gate is encountered. Gate 44 of the delivery point is communicated to by drone or through mobile networks to open on approach of drone 5, so only the correct gate opens.

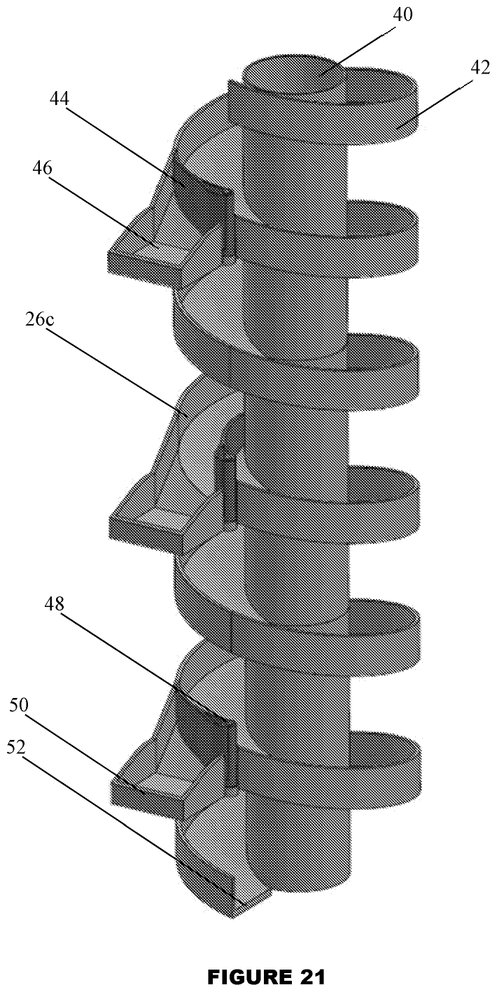

As can be seen in particular in FIG. 21 when open gate 44 bars the way for the item to travel any other way than to the delivery exit. Each gate 44 is hinged between an open and closed position about gate hinge 48, with gate post 49. Delivery exits 46, with stop 50 (break 52 showing where the channel continues) are indicated generally leading to the arrangement as described for delivery chute exits 28a and b, not shown.

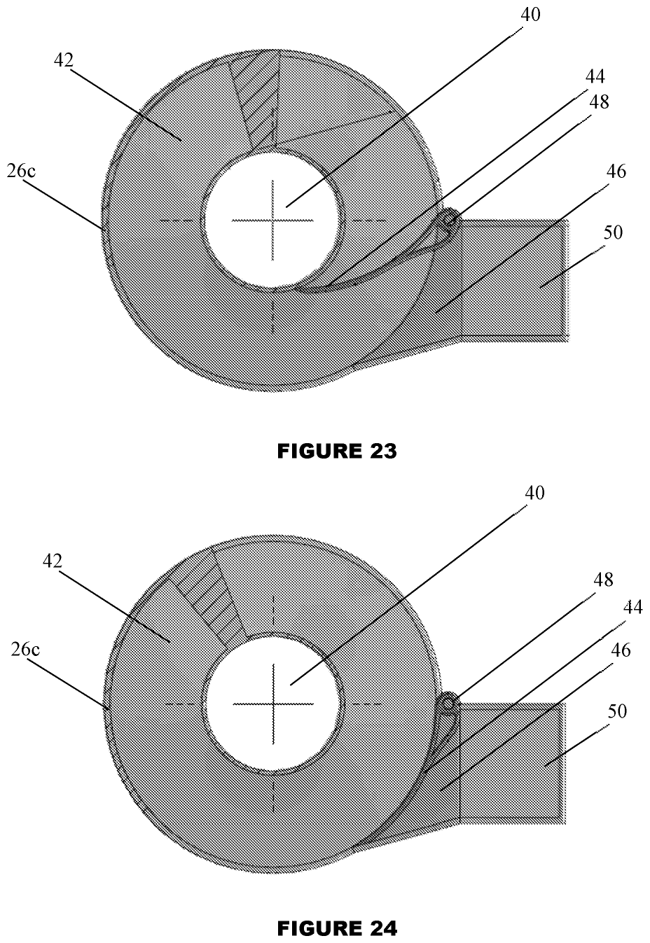

With reference to FIGS. 23 and 24 curved gate wall 54 can be seen to be especially designed to smoothly deflect items passing by without damage. Each gate 44 also has wall 54 with a tapered end, to lightly position between the open and closed position.

Referring to FIGS. 1 to 10, and 13 and 14, (Embodiment 4), a fourth preferred embodiment of the delivery system, delivery system 1d with funnel 22d, leading to wider conduit 24d is shown. Again larger parcels can be received in these configurations. The delivery is as described for embodiment 3, except that the spiral 26d is slightly different. In all other aspects the mechanism is the same.

The funnel of each of the embodiments appears different sizes as convenient for illustration but the size can be varied or may be the same. Preferably, the size of funnel for each is suitable to receive the packages to be delivered.

For any of the embodiments these may be installed when the building is constructed or may be retrofitted later. In one form of the invention the apparatus may be provided in modular form. The parts may be 3D printed as blocks. The blocks contain 1 revolution or half a revolution and be able to clip them together with reciprocating parts, to build down the entire height of the building. Each module would contain a means of passing electricity to operate the gates. This would also aid in maintenance as we could remove a malfunctioning module and easily replace it with a working module. It is even envisaged that the “package” may be sent to another person or firm with the 3D print and other instructions to install locally, and this could be sent from overseas, but the product made at the location for installation.

Clearly, the sophisticated system enables safe and gentle delivery of items to a secure location, suitable for personal retrieval at a later date.

A further form of invention is also under development that uses an elevator type mechanism that on receipt of the item takes communication from the drone to deliver to a particular delivery point and at that point tip the floor of the elevator to tip the item into the waiting container. Evidently, there is a very useful invention described and disclosed herein with different uses for different industries. The careful, automated handling of the item during the final stages of delivery will make a significant differences to the industry and allow consumer trust to be built in suppliers and delivery agencies who use the invention.

Overall, the inventor has developed a significant advance in drone delivery and directing of goods to the intended recipient.

REFERENCE SIGNS LIST:

| 1a | Delivery System |
|---|---|
| 1b | Delivery System |
| 1c | Delivery System |
| 1d | Delivery System |
| 5 | Drone |
| 10 | Building |
| 12 | Roof |
| 14 | Front wall |
| 16 | Floors of 10 |
| 18 | Floors of 10 |
| 20 | Floors of 10 |
| 22a | Funnels |
| 22b | Funnels |
| 22c | Funnels |
| 22d | Funnels |
| 24a | Conduit |
| 24b | Conduit |
| 24c | Conduit |
| 24d | Conduit |
| 26a | Delivery chute |
| 26b | Delivery chute |
| 26c | Delivery spiral |
| 26d | Delivery spiral |
| 28a | Delivery chute exit |
| 28b | Delivery chute exit |
| 30 | Package |
| 32 | Container |
| 34 | Door |
| 36 | |
| 40 | Post |
| 42 | Channel |
| 44 | Gate |
| 46 | Delivery exits |
| 48 | Gate hinge |
| 49 | Post of hinge |
| 50 | Stop/end |
| 52 | Break |
| 54 | Curved gate wall |
| 56 | Tapered end |

1-20. (canceled)

21. A directed delivery system, for drone delivery of an item to a location, the directed delivery system including:
a receptacle to receive the item at the location, and the drone delivery includes alignment with the correct receptacle within the GPS location and including a plurality of location means about the perimeter of the receptacle to specifically define where the item is to be placed, the location means being in communication with the drone such that the drone can align to the correct receptacle before release of the item within;
a securable container to receive the delivered item, spaced some distance from the receptacle, in substantially the vertical plane;
a conduit between the receptacle and the container that directs the item from one to the other minimising the risk of damage during travel, the conduit including a spiral arrangement which directs the movement of the item between the receptacle and the container, and one or more controlled gates, controlled in response to the delivery of the item by the drone, to direct the item into the correct container,
wherein drone delivery of the item to the location is so that the item is received in the receptacle within the perimeter defined by the location means, and directed through the spiral arrangement, and through the gates to the correct container at the desired delivery point with minimal impact to the item.

22. The directed delivery system of claim 21, wherein the directing is the directing of an item from the release by the drone to a position where the item may be retrieved by a person.

23. The directed delivery system of claim 21, wherein the directing of the item takes place at multiple points between the item entering the delivery system and the container, where the item may be retrieved.

24. The directed delivery system of claim 21, wherein the directing is from entering the delivery system to direct an item to a particular container, where there are more than one.

25. The directed delivery system according of claim 21, wherein there are multiple containers and the directing of the item is such that the item is delivered to the correct container.

26. The directed delivery system of claim 21, wherein the item may be chosen from the following group: books; clothing items; coffee, tea or similar beverages; drink items; electronics; food items; games items; shoes; sunglasses; toiletries; or any item ordered on-line.

27. The directed delivery system of claim 21, wherein the receptacle is substantially funnel shaped, and the shaping also directs the item.

28. The directed delivery system of claim 21, wherein the securable container is lockable.

29. The directed delivery system of claim 21, wherein the securable container is located inside a building where a person can retrieve the item and this is a very convenient place and or height for retrieval.

30. The directed delivery system of claim 21, wherein there are multiple delivery points and the spiral arrangement can carry the item to these multiple delivery points, and a gate, which on opening allows the item to pass to the container of the correct delivery point.

31. The directed delivery system of claim 21, wherein the gates are controlled wirelessly to open to direct the item to the correct container and delivery point.

32. The directed delivery system of claim 21, wherein the gate, when open, prevents the item from passing the entrance to the correct container.

33. The directed delivery system of claim 21, wherein the conduit includes a wall, which may be solid, mesh or wire.

34. The directed delivery system of claim 21, wherein the item is delivered in the same orientation as loaded to the drone, and the item can travel the whole way in the same orientation as loaded, until retrieval.

35. The directed delivery system of claim 21, wherein the spacing in the substantially vertical plane is replaced with any suitable spacing, not limited to the vertical plane.

36. The directed delivery system of claim 21, wherein the container is an apartment itself, so that the item is delivered into the locked apartment.

37. A method of directed drone delivery, to a directed delivery system according to claim 21, the directed delivery system including a receptacle, conduit with spiral arrangement and one or more gates, and container, for receipt of an item to a location, including the following steps:
a) receiving an item in the receptacle;
b) directing the item via the conduit in a controlled manner; and
c) containing the item at the delivery point, ready for retrieval by the user, if authorised to do so.

38. A method of directed drone delivery for receipt of an item to a location comprising:
a) providing a directed delivery system, for drone delivery of an item to a location, the directed delivery system including:
a receptacle to receive the item at the location, and the drone delivery includes alignment with the correct receptacle within the GPS location and including a plurality of location means about the perimeter of the receptacle to specifically define where the item is to be placed, the location means being in communication with the drone such that the drone can align to the correct receptacle before release of the item within;
a securable container to receive the delivered item, spaced some distance from the receptacle, in substantially the vertical plane;
a conduit between the receptacle and the container that directs the item from one to the other minimising the risk of damage during travel, the conduit including a spiral arrangement which directs the movement of the item between the receptacle and the container, and one or more controlled gates, controlled in response to the delivery of the item by the drone, to direct the item into the correct container,
wherein drone delivery of the item to the location is so that the item is received in the receptacle within the perimeter defined by the location means, and directed through the spiral arrangement, and through the gates to the correct container at the desired delivery point with minimal impact to the item;
b) receiving an item in the receptacle;
c) directing the item via the conduit in a controlled manner; and
d) containing the item at the delivery point, ready for retrieval by the user, if authorised to do so.
